(19) United States
(12) Patent Application Publication
(10) Pub. No.: US 2023/0016832 A1
(43) Pub. Date: Jan. 19, 2023

(54) COMPOSITE YOKE FOR ROTOR SYSTEM USING A COMBINATION OF BROAD GOODS AND CHOPPED FIBER LAYUP

(71) Applicant: Textron Innovations Inc., Providence, RI (US)

(72) Inventors: Amarjit KIZHAKKEPAT, Fort Worth, TX (US); Tyler Wayne BALDWIN, Keller, TX (US); Michael DEARMAN, Weatherford, TX (US); Abey KURIKESU, Fort Worth, TX (US)

(73) Assignee: Textron Innovations Inc., Providence, RI (US)

(21) Appl. No.: 17/953,807

(22) Filed: Sep. 27, 2022

Related U.S. Application Data
(62) Division of application No. 16/038,366, filed on Jul. 18, 2018.

(51) Int. Cl. B64C 27/32; B29C 70/08

(52) U.S. Cl. CPC B64C 27/32; B29C 70/081; B29L 2031/7498

(57) ABSTRACT

A composite yoke includes a plurality of packs of unidirectional plies and at least one pack of chopped fibers disposed between two adjacent packs of unidirectional plies. A method of manufacturing a composite yoke includes arranging a plurality of plies of unidirectional fibers to form a first pack of unidirectional plies, arranging a layer of chopped fibers on the first pack of unidirectional plies, arranging a plurality of plies of unidirectional fibers on to form a second pack of unidirectional plies on the layer of chopped fibers, curing the composite yoke to form a cured composite yoke, and cutting excess material from the first pack of unidirectional plies, the layer of chopped fibers, and the second pack of unidirectional plies to form a plurality of arms.

### CROSS-REFERENCE TO RELATED APPLICATION

This application is a division of U.S. application Ser. No. 16/038,366, filed Jul. 18, 2018, the contents of which are incorporated by reference in their entirety herein for all purposes.

### TECHNICAL FIELD

This invention relates generally to rotor systems, and more particularly, to a broad goods composite yoke for a rotor system.

### BACKGROUND

A rotorcraft includes one or more rotor systems. One example of a rotorcraft rotor system is a main rotor system. A main rotor system may generate aerodynamic lift to support the weight of the rotorcraft in flight and thrust to counteract aerodynamic drag and move the rotorcraft in forward flight. Another example of a rotorcraft rotor system is a tail rotor system. A tail rotor system may generate thrust in the same direction as the main rotor system's rotation to counter the torque effect created by the main rotor system.

### SUMMARY

Particular embodiments of the present disclosure may provide one or more technical advantages. A technical advantage of one embodiment may include the capability to reduce manufacturing costs of a composite yoke. A technical advantage of one embodiment may include the capability to produce a tiltrotor composite yoke without belted-blade retention straps.

A composite yoke includes a plurality of packs of unidirectional plies and at least one pack of chopped fibers disposed between two adjacent packs of unidirectional plies. A method of manufacturing a composite yoke includes arranging a plurality of plies of unidirectional fibers to form a first pack of unidirectional plies, arranging a layer of chopped fibers on the first pack of unidirectional plies, arranging a plurality of plies of unidirectional fibers on to form a second pack of unidirectional plies on the layer of chopped fibers, applying a resin to the first pack of unidirectional plies, the layer of chopped fibers, and the second pack of unidirectional plies and curing the resin to form a cured composite yoke, and cutting excess material from the first pack of unidirectional plies, the layer of chopped fibers, and the second pack of unidirectional plies to form a plurality of arms.

Certain embodiments of the present disclosure may include some, all, or none of the above advantages. One or more other technical advantages may be readily apparent to those skilled in the art from the figures, descriptions, and claims included herein.

### BRIEF DESCRIPTION OF THE DRAWINGS

To provide a more complete understanding of the present invention and the features and advantages thereof, reference is made to the following description taken in conjunction with the accompanying drawings, in which:

FIG. 1A is a tiltrotor aircraft according to one aspects of the disclosure;

FIG. 1B is an example of a rotor system according to aspects of the disclosure;

FIG. 2A is a perspective view of a prior art yoke of a rotor system;

FIG. 2B is a cross-sectional view of the yoke of FIG. 2A;

FIG. 3A is a perspective view of a schematic view of a yoke cross-section according to one or more aspects of the disclosure;

FIG. 3B is a schematic cross-sectional view of a yoke according to one or more aspects of the disclosure;

FIG. 3C is a schematic cross-sectional view of a yoke according to one or more aspects of the disclosure;

FIG. 3D is a schematic cross-sectional view of a yoke according to one or more aspects of the disclosure; and

FIG. 4 illustrates different layups of a yoke according to one or more aspects of the disclosure.

### DETAILED DESCRIPTION OF THE DRAWINGS

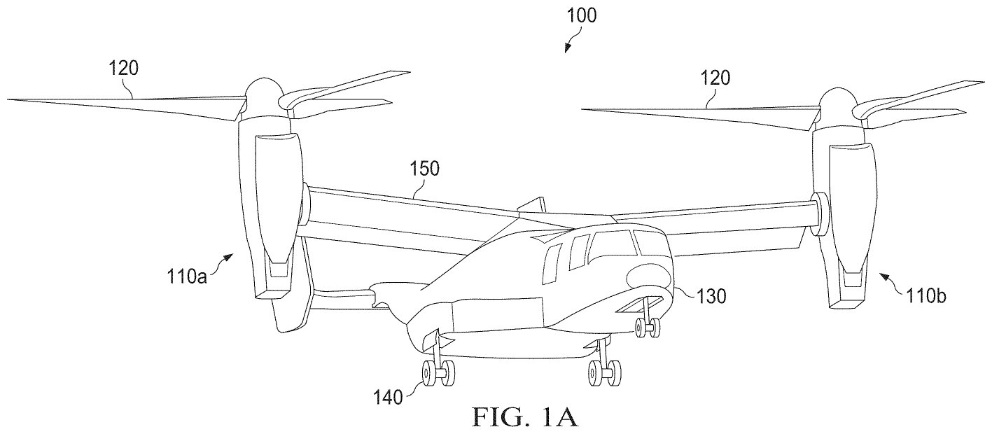

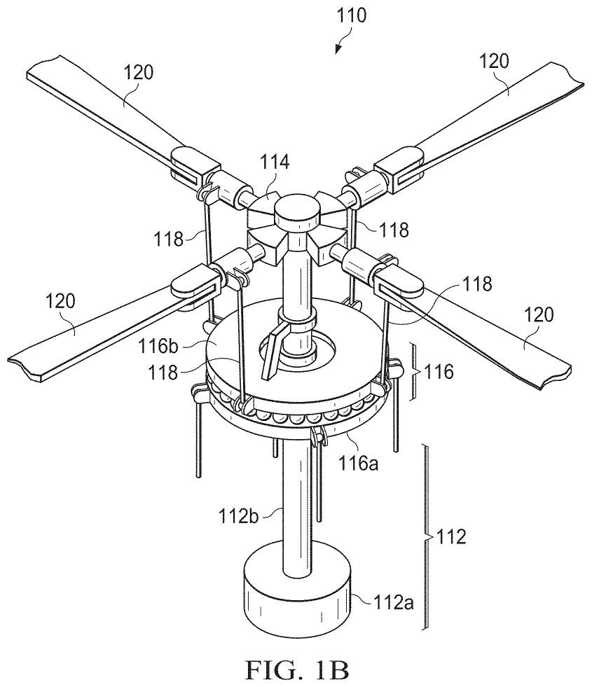

FIG. 1A shows an example of a tiltrotor aircraft 100. Tiltrotor aircraft 100 features rotor systems 110a and 110b, blades 120, a fuselage 130, a landing gear 140, and a wing 150. Rotor systems 110a, 110b are used to rotate blades 120 and may include a control system for selectively controlling the pitch of each blade 120 in order to selectively control direction, thrust, and lift of tiltrotor aircraft 100. In the example of FIG. 1A, rotor systems 110a and 110b includes rotatable nacelles, the position of which, as well as the pitch of blades 120, can be selectively controlled in order to selectively control direction, thrust, and lift of tiltrotor aircraft 100. Fuselage 130 represents the main body of tiltrotor aircraft 100 and may be coupled to rotor system 110 (e.g., via wing 150) such that rotor system 110 and blades 120 may move fuselage 130 through the air. Landing gear 140 supports tiltrotor aircraft 100 when tiltrotor aircraft 100 is landing and/or when tiltrotor aircraft 100 is at rest on the ground.

Teachings of certain embodiments relating to rotor systems described herein may apply to rotor system 110 and/or other rotor systems, such as non-tilting rotor and helicopter rotor systems. It should also be appreciated that teachings from tiltrotor aircraft 100 may apply to aircraft other than rotorcraft, such as airplanes and unmanned aircraft, to name a few examples.

In the example of FIG. 1A, tiltrotor aircraft 100 may operate in a helicopter mode by tilting the nacelles upright and in an airplane mode by tilting the nacelles forward. Tiltrotor aircraft 100 may generate greater forward speed in airplane mode than in helicopter mode because, in airplane mode, blades 120 are oriented to generate greater thrust propelling the aircraft forward (somewhat analogous to a propeller).

FIG. 1B shows a simplified example of a rotor system 110 that may be incorporated in whole or in part in the tiltrotor aircraft 100 of FIG. 1A. In the example of FIG. 1B, rotor system 110 features a power train 112, a yoke 114, a swashplate 116, and pitch links 118. In some examples, rotor system 110 may include more or fewer components. For example, FIG. 1B does not show components such as a gearbox, drive links, drive levers, tilting devices, and other components that may be incorporated.

Power train 112 features a power source 112a and a drive shaft 112b. Power source 112a, drive shaft 112b, and yoke 114 are mechanical components for transmitting torque and/or rotation. Power train 112 may include a variety of components, including an engine, a transmission, and differentials. In operation, drive shaft 112b receives torque or rotational energy from power source 112a and rotates yoke 114. Rotation of yoke 114 causes blades 120 to rotate about drive shaft 112b. FIG. 1B shows four blades 120, but rotor system 110 may include more or fewer blades in other embodiments. In some embodiments, power train 112 may include more or fewer components. For example, in some embodiments, tilting devices may be provided in mechanical communication with power train 112 that allows certain components of rotor system 110 to tilt between helicopter mode and airplane mode.

Swashplate 116 translates rotorcraft flight control input into motion of blades 120. Because blades 120 are typically spinning when the rotorcraft is in flight, swashplate 116 may transmit flight control input from the non-rotating fuselage to the yoke 114, blades 120, and/or components coupling yoke 114 to blades 120 (e.g., grips and pitch horns). References in this description to coupling between a pitch link and a yoke may also include, but are not limited to, coupling between a pitch link and a blade or components coupling a yoke to a blade.

In some examples, swashplate 116 may include a non-rotating swashplate ring 116a and a rotating swashplate ring 116b. Non-rotating swashplate ring 116a does not rotate with drive shaft 112b, whereas rotating swashplate ring 116b does rotate with drive shaft 112b. In the example of FIG. 1B, pitch links 118 connect rotating swashplate ring 116b to blades 120.

In operation, according to one example embodiment, translating the non-rotating swashplate ring 116a along the axis of drive shaft 112b causes the pitch links 118 to move up or down. This changes the pitch angle of all blades 120 equally, increasing or decreasing the thrust of the rotor and causing the aircraft to ascend or descend. Tilting the non-rotating swashplate ring 116a causes the rotating swashplate 116b to tilt, moving the pitch links 118 up and down cyclically as they rotate with the drive shaft. This tilts the thrust vector of the rotor, causing tiltrotor aircraft 100 to translate horizontally following the direction the swashplate is tilted.

During operation, yoke 114 and other components of rotor system 110 may be subject to a variety of forces. Examples of such forces may include, but are not limited to, flapping, coning, axial, lead/lag, and feathering forces. Such forces may cause damage to yoke 114 and other components of rotor system 110 during operation if, for example, the magnitude of the forces is too high or the motions causing such forces occur too frequently. Accordingly, teachings of certain embodiments recognize the capability to provide a yoke that can withstand these and other forces.

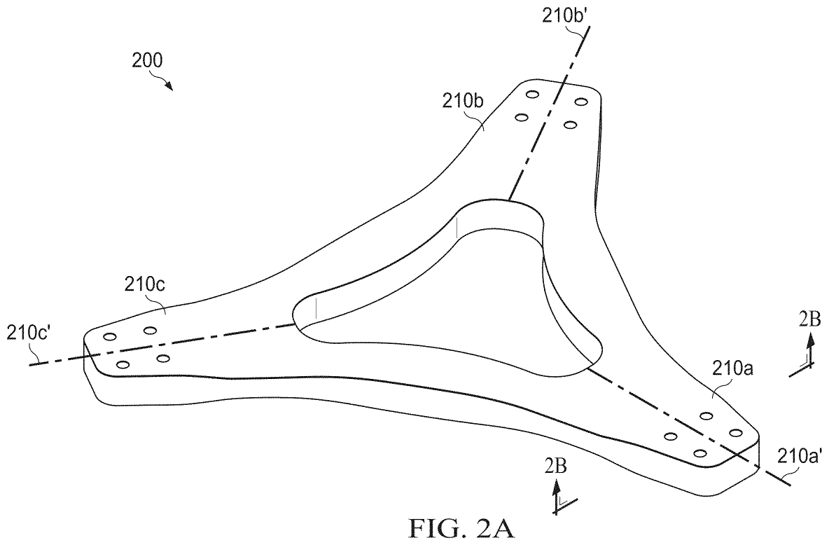

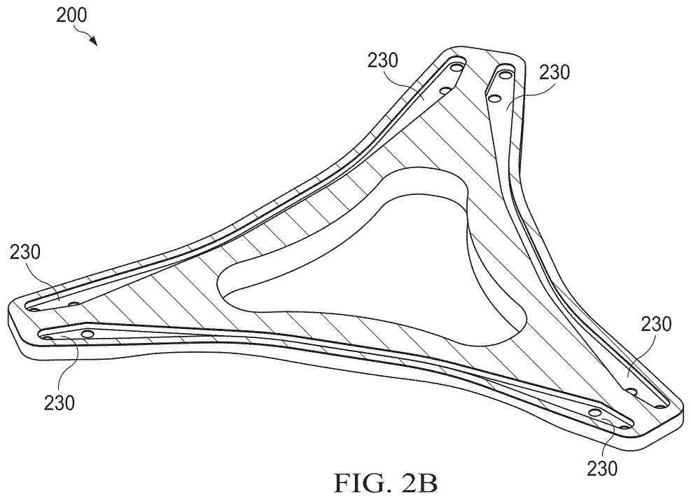

FIGS. 2A-2B illustrate an embodiment of a prior art yoke 200. FIG. 2A shows a perspective view of the yoke 200 and FIG. 2B shows a cross-sectional view through a face of the yoke 200. Yoke 200 features three arms 210a, 210b, and 210c oriented along corresponding axes 210a′, 210b′, and 210c′.

In the example of FIGS. 2A-2B, yoke 200 represents a composite yoke. Yoke 200 may include several belted-blade retention straps 230 disposed among layers of fibers. For example, straps 230 may be disposed among packs of plies. Each pack including either unidirectional plies or shear plies. Each strap 230 increases the strength of yoke 200 by extending from one arm to an adjacent arm. In combination, straps 230 may distribute forces across yoke 200 by transferring forces from each yoke arm to the adjacent yoke arms. Inclusion of straps 230 adds complexity to the manufacturing process that results in a higher cost of manufacture. For example, as seen in FIG. 2B, each cross-section layer of yoke 200 includes three straps 230 as well as additional pieces of material arranged inside, between, and around straps 230 to complete the shape of yoke 200.

Each pack may include different types of plies. For example, each pack may include a plurality of unidirectional plies or a plurality of shear plies. In an exemplary embodiment, each pack includes three plies. Packs of unidirectional plies are used to handle large centrifugal force loads generated during operation of the rotor assembly. Unidirectional plies may be aligned along arms of the yoke in order to maximize the load carrying capability of an arm of the yoke. For example, each arm 210a-c may include unidirectional plies oriented to be generally parallel with axes 210 a′-c′, respectively. Packs of shear plies are interspersed between packs of unidirectional plies to increase an overall strength of yoke 200 by distributing loads between the various unidirectional plies of yoke 200.

The process of aligning straps 230 and arranging the various packs of unidirectional plies and shear plies inside, between, and around straps 230 can be quite time-consuming and expensive. This process must be repeated for each pack of yoke 200.

Accordingly, teachings of certain embodiments of the instant application recognize the capability to reduce the time and labor needed to manufacture a composite yoke, thus reducing the cost of producing the composite yoke. This savings in time and cost is achieved by reducing the number of plies necessary to form the yoke. In particular, teachings of certain embodiments recognize the capability to produce a broad goods yoke that uses fewer plies of material to form the composite yoke. The term “broad goods” is a term of art that indicates that sheets or tapes of plies of a certain width. As used here, “broad goods” is used to describe sheets of plies having widths of approximately twelve inches. Teachings of certain embodiments recognize the capability to reduce the number of plies used to form the yoke by replacing packs of shear plies with layers of chopped fibers. The chopped fibers may be incorporated into the yoke by using mats of chopped fibers or preforms of chopped fibers. Embodiments of the composite yoke also eliminate the need for straps 230, the elimination of which further decreases construction cost.

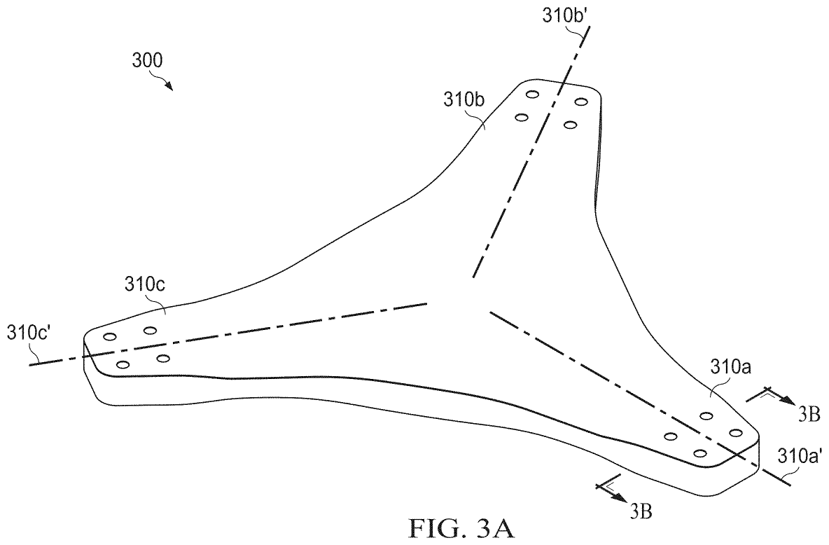

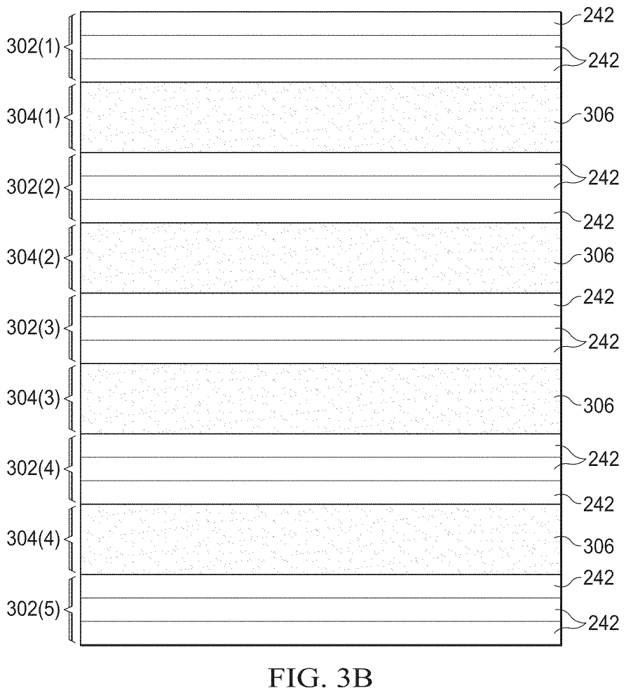

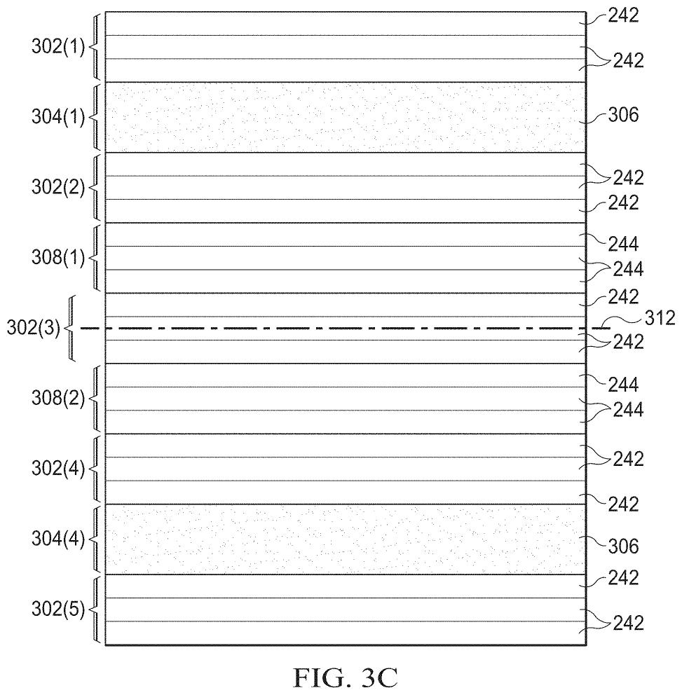

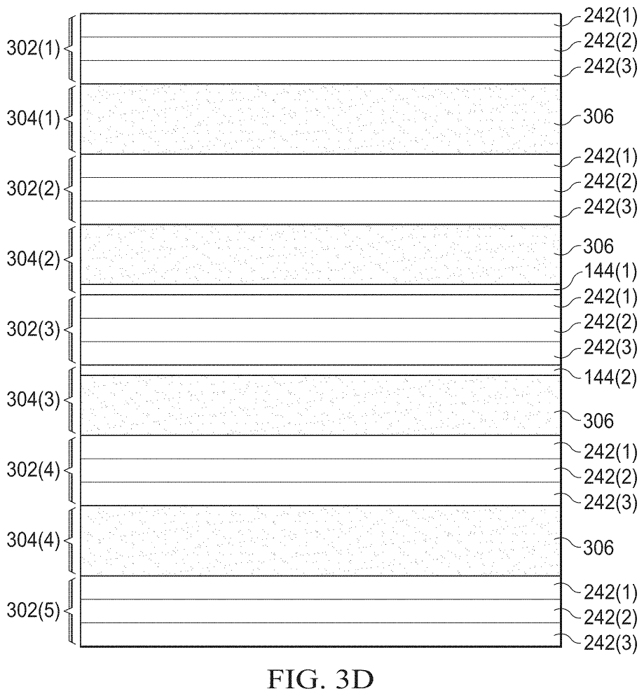

FIGS. 3A and 3B illustrate an embodiment of a yoke 300. FIG. 3A is a perspective view of a yoke 300 according to aspects of the disclosure and FIG. 3B is a schematic representation of a cross-sectional view through an arm of yoke 300. Yoke 300 features three arms 310a, 310b, and 310c oriented along corresponding axes 310a′, 31011′, and 310c′. Yoke 300 is formed from multiple layers of material. For example, yoke 300 may comprise hundreds of layers of unidirectional plies. Yoke 300 also includes chopped fiber layers that are disposed between the layers of unidirectional plies. In some embodiments, yoke 300 incudes a combination of unidirectional plies, shear plies, and chopped fiber layers. In some embodiments, belted-blade retention straps may be incorporated to improve strength of yoke 300.

FIG. 3B illustrates schematically an exemplary layering of materials that form arm 310a of yoke 300. Arms 310b and 310c have a similar structure to arm 310a. Arm 310a is discussed below, but it should be understood that the description of arm 310a equally applies to arms 310b and 310c. Arm 310a includes packs 302(1)-(5). In the embodiment of FIG. 3B, each pack 302 includes three unidirectional plies 242. Examples of unidirectional ply materials includes s-glass/epoxy tape, carbon fiber/epoxy tape, continuous filament mat such as Owens Corning Uniflo®, and multi-end continuous roving mat such as Owens Corning multi-end continuous roving mat. Each unidirectional ply 242 comprises a sheet of unidirectional fibers, wherein each of the unidirectional fibers of the sheet is generally aligned in the same direction. In other embodiments, each pack 302(1)-(5) may include more or fewer than three unidirectional plies 242 (e.g., as few as one ply and four or more plies). In some embodiments, a number of unidirectional plies in a pack 302 varies based on a location of the pack 302. For example, packs 302 located near a middle layer portion of yoke 300 may include more unidirectional plies than packs 302 located closer to a top or bottom of yoke 300. Unidirectional plies 242 are oriented generally parallel to axis 310 a′. Orienting the unidirectional plies 242 in this way allows unidirectional plies 242 to maximize an amount of centrifugal force that arm 310a can support.

Yoke 300 also includes packs 304(1)-(4) of chopped fibers 306 that are disposed between packs 302(1)-(5) as illustrated in FIG. 3B. Compared to yoke 200 of FIGS. 2A-2B, packs 304(1)-(4) may replace packs of shear plies. Examples of chopped fiber material includes AF163 with chopped glass, FM300 with chopped glass, chopped strand mat (“CSM”) such as Owens Corning chopped strand mat, and HexMC® from Hexcel. In some embodiments, chopped fibers 306 are provided as a mat of chopped fibers. In some embodiments, chopped fibers 306 are provided as a preform. The term “preform” refers to a resinous chopped fiber material that has not been fully cured and is still malleable. In some embodiments, outer most packs of yoke 300 are packs 302 including unidirectional fibers.

Replacing packs of shear plies with packs 304 of chopped fiber 306 reduces a cost of manufacturing yoke 300 compared to yoke 200. A reduction in cost is possible because chopped fiber 306 costs less than shear plies 244 and because chopped fiber 306 is applied as a single step or layer during the manufacturing process. In contrast, packs 240 of shear plies 244 usually include at least three layers of shear ply 244, each layer of which must be independently laid. Comparing the manufacturing process of yoke 300 to yoke 200, FIG. 3B illustrates that twelve layers of shear plies 244 have been replaced by four packs 304 of chopped fiber 306. FIG. 3B is a simple schematic representation of yoke 300. In practice, yoke 300 is comprised of hundreds of layers of plies. Utilizing the design of yoke 300 that incorporates packs 304 of chopped fiber 306, a reduction of hundreds of ply layers is possible. This reduction reduces the cost of yoke 300 because the time to manufacture yoke 300 and the total cost of materials is reduced.

FIG. 3C illustrates an embodiment of yoke 300 that combines packs of unidirectional plies, packs of shear plies, and packs of chopped fiber. Comparing FIG. 3C to FIG. 3B, packs 302(1)-(5) remain and packs 304(2) and 304(3) have been replaced with packs 308(1) and 308(2) that contain shear plies 244. The embodiment of FIG. 3C still offers a reduction in manufacturing time and cost, while offering different mechanical properties. Replacing chopped fibers 306 with shear plies 244 close to a centerline 312 of yoke 300 provides improved shear capabilities near the centerline 312. It should be understood that FIG. 3C is illustrative of a basic design of yoke 300. In practice, yoke 300 may include more packs 302, 306, and 308 than illustrated in FIG. 3C. In various embodiments, yoke 300 may include more than two packs 308. For example, yoke 300 may include a middle layer portion that includes alternating layers of packs 302 and 308 and two outer layer portions that each include alternating layers of packs 302 and 304. With reference to FIG. 3C, the middle layer portion may include packs 308(1), 302(3), and 308(2), a first outer layer portion may include packs 302(1), 304(1), and 302(2), and a second outer layer portion may include packs 302(4), 304(4), and 302(5). In practice, each of the middle layer portion and the outer layer portions may include more than three packs.

FIG. 3D illustrates an embodiment of yoke 300 that combines packs of unidirectional plies, packs of shear plies, and packs of chopped fiber. Different methods can be used to adhere packs 302 and 304 together to form yoke 300. For example, as illustrated in FIG. 3D, a film 144 may be inserted between adjacent packs 302 and 304. FIG. 3D illustrates a film 144(1) inserted between packs 304(2), 302(3) and a film 144(2) inserted between packs 302(3), 304(3). Films 144(1), 144(2) may comprise a sheet or film that includes an adhesive or resin. During the curing process, the adhesive or resin wets out and packs positioned on either side of film 144 are adhered together. For example, film 144(1) adheres to pack 304(2) and pack 302(3) and film 144(2) joins packs 304(3) and 302(2) together. Although only two films 144 are shown in FIG. 3D, additional films 144 may be inserted between other adjacent packs as desired. During the manufacturing process, yoke 300 is built up by stacking layers of packs 302 and packs 304. Films 144 may be placed between any adjacent packs of yoke 300 during the manufacturing process.

In some embodiments, packs 302 may comprise an adhesive or resin. The adhesive or resin may be added to packs 302 during buildup of yoke 300 or packs 302 may include an increased adhesive or resin content. Using packs with an increased adhesive or resin content provides excess adhesive or resin that wets out to adhere adjacent packs. In some embodiments, an increased adhesive or resin content means an adhesive or resin content of more than about 35% by weight. In other embodiments, an increased adhesive or resin content may be an adhesive or resin content of more than about 30% by weight. In some embodiments, plies 242 within packs 302 may comprise an adhesive or resin. For example, one or more of plies 242(1)-(3) may comprise adhesive or resin. As plies 242 comprising adhesive or resin are applied to yoke 300, any ply or pack placed upon plies 242 comprising adhesive or resin will be adhered thereto during the cure process. For example, ply 242(3) of pack 302(2) may comprise an adhesive or resin that is impregnated into ply 242(3) or applied to a surface of ply 242(3). The adhesive or resin of ply 242(3) of pack 302(2) helps adhere pack 302(2) to pack 304(2) (as well as to ply 242(2)). Similarly, ply 242(1) of pack 302(2) may comprise an adhesive or resin that is impregnated into ply 242(1) or applied to surfaces of ply 242(1). The adhesive or resin of ply 242(1) of pack 302(2) helps adhere pack 302(2) to pack 304(1) (as well as ply 242(2)). Although only plies 242(1) and 242(3) of pack 302(2) were discussed, in various embodiments, any ply 242 of yoke 300, including any ply 242(2), could comprise an adhesive or resin.

In some embodiments, packs 304 may be treated with an adhesive or resin that is impregnated into packs 304. In some embodiments, packs 304 may come with resin already applied. In other embodiments, the adhesive or resin can be added to packs 304 prior to the manufacturing process or during the manufacturing process. For example, packs 304(1)-304(3) may comprise an adhesive or resin that helps bond together adjacent layers within yoke 300. In embodiments comprising packs 304(1)-304(3) with adhesive or resin, the curing process adheres packs 302 and 304.

In some embodiments, combinations of using films 144, plies 242 that comprise an adhesive or resin, and packs 304 that comprise an adhesive or resin may be used in building up yoke 300.

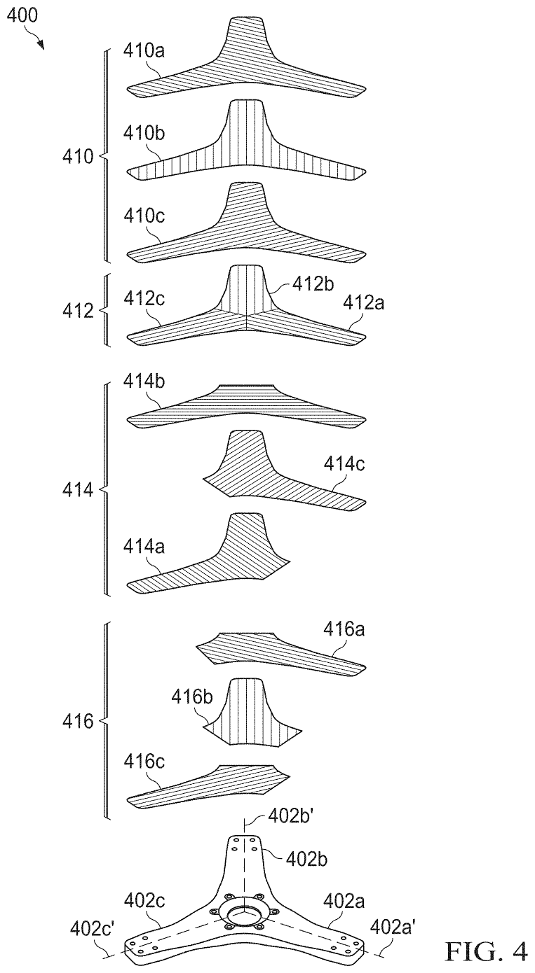

FIG. 4 illustrates plies 410-416 that provide different configurations for unidirectional plies in a yoke 400. Plies 410 illustrate plies that extend throughout the whole cross-section of yoke 400. Plies 410-416 may begin as rectangular sheets that are trimmed to a desired shape. Trimming of plies 410-416 may occur before, during, or after layup and cure. Plies 410a, 410b, and 410c each include unidirectional fibers. A general orientation of the unidirectional fibers in each ply 410a-c is indicated generally in FIG. 4 by the illustrated lines. Ply 410a includes unidirectional fibers generally aligned with axis 402a′, ply 410b includes unidirectional fibers generally aligned with axis 402b′, and ply 410c includes unidirectional fibers generally aligned with axis 402c′. Each of the plies 410a-c extend continuously across all of the arms 402a-c such that each ply acts as a unidirectional ply on one arm and as a crossply on the other two arms.

Different combinations of plies 410a-c can be used to form packs. For example, packs 302 discussed above relative to FIGS. 3A-3C can include combinations of plies 410a-c. A pack 302 may comprise three of the same plies or a combination of two or more plies 410a-c. Similar to yoke 300 discussed above relative to FIGS. 3A-3C, yoke 400 can include packs of chopped fibers 306 between packs of plies 410 (e.g., similar to FIG. 3B). In some embodiments, yoke 400 includes packs of chopped fibers 306 and packs shear plies 244 between packs of plies 410 (e.g., similar to FIG. 3C).

In addition to providing single-direction broad goods plies like plies 410a-c, teachings of certain embodiments recognize the ability to provide broad goods plies having fibers in multiple directions. Teachings of certain embodiments recognize the capability to improve yoke strength in specific areas by providing additional layers of plies that do not extend continuously across all of the arms 402a-c. For example, ply 412 features three plies 412a, 412b, and 412c, each ply having fibers that are aligned in a direction that is substantially parallel to the axis of a corresponding arm of yoke 400. Thus, in this example, the fibers of plies 412a-c may each act as unidirectional plies for their respective arm. Different combinations of plies 412a-c can be used to form packs. For example, packs 302 discussed above relative to FIGS. 3A-3C can include combinations of plies 412a-c. A pack 302 may comprise three of the same plies 412a-c or a combination of two or more plies 412a-c. Plies 416a-c are similar to plies 412a-c, but each ply 412 includes additional material near the center of yoke 400 that helps to transfer loads to other arms of yoke 300.

Teachings of certain embodiments recognize that providing sets of plies such as sets 414 and 416 may allow for fewer butt splices & ply terminations in the center section and for better load transfer across arms 402a-c of yoke 400. Plies 414 illustrate plies that generally conform to two arms 402a-c of yoke 400. Plies 414a, 414b, and 414c each include unidirectional fibers and are similar to plies 410a-c, except that plies 412a-c do not extend throughout the whole cross-section of yoke 400. Instead, as illustrated in FIG. 4, each of plies 414a-c generally covers two arms of arms 402a-c. Ply 414a includes unidirectional fibers generally aligned with axis 402a′, but ply 414a does not cover arm 402a. Ply 414b includes unidirectional fibers generally aligned with axis 402b′, but ply 414b does not cover arm 402b. Ply 414c includes unidirectional fibers generally aligned with axis 402c′, but ply 414c does not cover arm 402c. Different combinations of plies 414a-c can be used to form packs. For example, packs 302 discussed above relative to FIGS. 3A-3C can include combinations of plies 302a-c. In some embodiments, pack 302 may comprise three of the same plies 414a-c or a combination of two or more plies 414a-c.

In some embodiments, yokes may include more, fewer, or different plies than those described herein. For example, in one embodiment, a yoke may feature a combination of plies 242, 244, 410, 412, 414, and 416. In addition, a yoke may feature other plies in addition to or in place of some or all of plies 242, 244, 410, 412, 414, and 416. In some embodiments, chopped fiber mats or preforms may comprise similar configurations as plies 242, 244, 410, 412, 414, and 416.

Yokes 300 and 400 may be treated with resin and cured. In some embodiments, excess material from yokes 300 and 400 is removed prior to curing. In some embodiments, excess material from yokes 300 and 400 is removed after curing. In some embodiments, curing takes place in an autoclave.

Chopped fibers are discussed herein by way of example. Embodiments that include chopped fibers could instead include short fibers. In some embodiments, a yoke may include layers of chopped fibers and layers of short fibers.

Modifications, additions, or omissions may be made to the systems and apparatuses described herein without departing from the scope of the invention. The components of the systems and apparatuses may be integrated or separated. Moreover, the operations of the systems and apparatuses may be performed by more, fewer, or other components. The methods may include more, fewer, or other steps. Additionally, steps may be performed in any suitable order.

Although several embodiments have been illustrated and described in detail, it will be recognized that substitutions and alterations are possible without departing from the spirit and scope of the present invention, as defined by the appended claims.

To aid the Patent Office, and any readers of any patent issued on this application in interpreting the claims appended hereto, applicants wish to note that they do not intend any of the appended claims to invoke paragraph 6 of 35 U.S.C. § 112 as it exists on the date of filing hereof unless the words “means for” or “step for” are explicitly used in the particular claim.

1-13. (canceled)

14. A method of manufacturing a composite yoke, the method comprising:
arranging a plurality of plies of unidirectional fibers to form a first pack of unidirectional plies;
arranging a layer of chopped fibers on the first pack of unidirectional plies;
arranging a plurality of plies of unidirectional fibers to form a second pack of unidirectional plies on the layer of chopped fibers;
curing the composite yoke to form a cured composite yoke; and
cutting excess material from the first pack of unidirectional plies, the layer of chopped fibers, and the second pack of unidirectional plies to form a plurality of arms.

15. The method of claim 14, further comprising arranging a pack of shear plies between a third pack of unidirectional plies and a fourth pack of unidirectional plies.

16. The method of claim 15, wherein the composite yoke comprises:
a middle layer portion that comprises at least one pack of unidirectional plies and the pack of shear plies; and
a pair of outer layer portions disposed on opposite sides of the middle layer portion, each outer layer portion of the pair of outer layer portions comprising at least one pack of unidirectional plies and at least one pack of chopped fibers.

17. The method of claim 16, wherein:
the at least one pack of unidirectional plies of the middle layer portion comprises a first number of unidirectional plies; and
the at least one pack of unidirectional plies of the pair of outer layer portions comprises a second number of unidirectional plies;
wherein the first number of unidirectional plies is greater than the second number of unidirectional plies.

18. The method of claim 14, further comprising placing a film comprising resin between the first pack of unidirectional plies and the layer of chopped fibers.

19. The method of claim 14, wherein the first pack of unidirectional plies comprises a resin content of greater than 35%.

20. The method of claim 14, wherein the layer of chopped fibers comprises resin that helps adhere the layer of chopped fibers to the first and second packs of unidirectional plies.
